(19) United States
(12) Patent Application Publication
(10) Pub. No.: US 2012/0202376 A1
(43) Pub. Date: Aug. 9, 2012

(54) Mating Support Member For Electrical Connectors and Method of Mating Electrical Connectors

(76) Inventor: Katsumi Shiga, Chiba (JP)

(21) Appl. No.: 13/365,659

(22) Filed: Feb. 3, 2012

(30) Foreign Application Priority Data
Feb. 4, 2011 (JP) 2011-022995

(51) Int. Cl. H01R 13/60

(52) U.S. Cl. 439/533

(57) ABSTRACT

A mating support member that mates a first electrical connector and a second electrical connector with each other. The support member includes a support member main body having a protrusion receiving passageway, a lever disposed on an opposite side of the protrusion receiving passageway, and a cam section formed in the support member main body between the protrusion receiving passageway and the lever. The cam section includes a first receiving passageway formed at one end of the cam section, a second receiving passageway formed at another end of the cam section, and a cam groove that is formed between and continuous with the first receiving passageway and the second receiving passageway and for presses first and second connectors together.

### FIELD OF THE INVENTION

The present invention relates to a mating support member and, in particular, a mating support member for connecting at least two electrical connectors.

### BACKGROUND

Recent electrical connectors (referred to simply as connectors hereinafter) used in automobiles or other applications have increased numbers of terminals. Such connectors with multiple terminals require greater forces for mating or decoupling. In automobiles or other applications, lever-type connectors are used, which are mated with or decoupled from mating connectors with the aid of the force magnifying effect of a lever.

In some cases, however, the connector may be used in a narrow space where there is not enough room to accommodate the lever or allow movement of the lever.

Even connectors of the same type may have different numbers of terminals depending on e models of the products in which the connectors are used. The mating force of the connector varies by the number of terminals. For example, a connector with a large number of terminals may be unable to be mated with a mating connector without a lever, while a connector with a small number of terminals may be able to be manually and easily mated with a mating connector. In the latter case, a lever is a useless equipment.

In view of such a circumstance, there are known connectors having a removable lever (see Japanese Patent Laid-Open No. 2002-25688 and Japanese Patent Laid-Open No. 2007-42509, for example).

In these documents, a male connector and a female connector to be mated with each other each have a protrusion or the like. To mate the male connector and the female connector with each other, a lever with a groove or the like formed therein is attached to these protrusions. When the lever is rotated around one of the protrusions, which serves as a fulcrum, the other protrusion is guided along the groove and pressed, thereby forcing the male and female connectors to mate with each other.

The removable lever described above is useful for mating the connectors with each other but may be useless for decoupling the connectors from each other.

In addition, depending on the position of the connectors, the lever may interfere with the surrounding components. In such a case, the position or posture of the connectors has to be changed, or a special lever for such a situation has to be prepared, since the state of attachment (posture) of the lever with respect to the connectors cannot be changed. Thus, workability and cost problem arise: restrictions are imposed on the placement (layout) of the connectors, and plural types of levers have to be prepared.

### SUMMARY

The present invention has been devised in view of such technical problems, and an object of the invention, among others, is to provide a mating support member for electrical connectors and a method of mating electrical connectors that can decouple(separate) the mated connectors as well as mating of the connectors.

The support member includes a support member main body having a protrusion receiving passageway, a lever disposed on an opposite side of the protrusion receiving passageway, and a cam section formed in the support member main body between the protrusion receiving passageway and the lever. The cam section includes a first receiving passageway formed at one end of the cam section, a second receiving passageway formed at another end of the cam section, and a cam groove that is formed between and continuous with the first receiving passageway and the second receiving passageway and for presses first and second connectors together.

### BRIEF DESCRIPTION OF THE DRAWINGS

The objects, features and advantages of the invention will become more apparent by describing in detail embodiments thereof with reference to the accompanying drawings, in which:

FIG. 1 is a perspective view of a first electrical connector and a second electrical connector to be mated with each other using a mating support member according to the invention;

FIGS. 2A is another perspective view of the first electrical connector and the second electrical connector being mated with each other using the mating support member according to the invention;

FIG. 2B is a side view showing the mating support member attached to the first electrical connector and the second electrical connector;

FIG. 3A is a perspective view showing a second protrusion disposed on the second electrical connector is moved into a cam groove of the mating support member;

FIG. 3B is a close-up view showing a relationship between the width of the cam groove and the diameter of an expanded part of the second protrusion;

FIG. 3B is a side view showing a second protrusion disposed on the second electrical connector is moved into a cam groove of the mating support member;

FIG. 4A is a perspective view showing the second protrusion disposed on the second electrical connector that has reached a second receiving passageway of the support member;

FIG. 4B is a side view showing the second protrusion disposed on the second electrical connector that has reached a second receiving passageway of the mating support member;

FIG. 5 is a perspective view of the mating support member after removale from the first electrical connector and the second electrical connector;

FIGS. 6A to 6C are side view of showing connection and disconnection of the first electrical connector and second electrical connector when the mating support member is rotated; and

FIG. 7A is a perspective view showing another mating support member according to the invention; and

FIG. 7B is a side view showing the mating support member in FIG. 7A.

### DETAILED DESCRIPTION OF THE EMBODIMENT(S)

in the following, the present invention be described in detail with reference to an embodiment shown in the accompanying drawings.

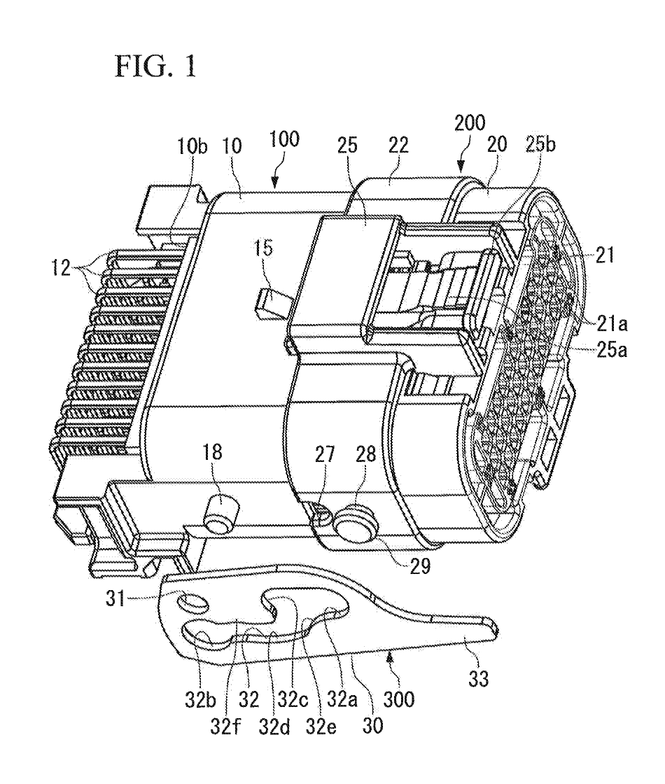

With reference to FIGS. 1 to 5, a male connector 100 and a female connector 200 to be mated with each other are shown, each having a housing 10, 20 with a plurality of contacts (not shown), respectively.

In the embodiment shown, the housing 10 of the male connector 100 is made of an insulating material, such as a resin, and has a plurality of contact receiving passageways that penetrate through the housing 10 in the direction from a facing surface, which faces the female connector 200, to an opposite surface 10b. A female contact 12 made of a conductive material is inserted into each contact receiving passageway. A tip end 12a of the female contact 12 protrudes from the opposite surface 10b of the housing 10 and is electrically connected to a wiring pattern on a circuit board (not shown).

In the embodiment shown, the housing 20 of the female connector 200 is made of an insulating material, such as a resin, and has a terminal holding member 21 having a plurality of contact receiving passageways 21a that hold a plurality of male contacts (not shown).

The shown housing 20 has a tubular hood 22 that extends from the terminal holding member 21 toward the male connector 100 to be mated with. Within the hood 22, the male contacts (not shown) held in the terminal holding member 21 are positioned to protrude from the terminal holding member 21 toward the male connector 100 and then to be mated there with. Wires (not shown) connected to the male contacts are drawn from the terminal holding member 21 in the direction away from the male connector 100.

The shape of the female contacts 12, the orientation of the housing 10 with respect to the circuit board and the like are not particularly limited.

An engaging member 15 is formed on the outer peripheral part of the housing 10 of the male connector 100, and a lock 25 having an elastic lever 25a capable of being engaged with the engaging member 15 is formed on the housing 20 of the female connector 200.

When the male connector 100 and the female connector 200 are mated with each other, the elastic lever 25a of the lock 25 is engaged with the engaging member 15 to maintain and secure connection of the male connector 100 and the female connector 200 in the mated state. The elastic lever 25a can be disengaged from the engaging member 15 by pressing a manipulating part 25b of the elastic lever 25a.

In the embodiment showing, a first protrusion 18 is formed on the outer peripheral part of the housing 10 of the male connector 100, and a second protrusion 28 is formed on the outer peripheral part of the housing 20 of the female connector 200. The first protrusion 18 on the outer peripheral part of the housing 10 of the male connector 100 is formed in such a part that the first protrusion 18 is not received in the hood 22 and exposed to the outside when the male connector 100 and the female connector 200 are mated with each other. On the other hand, the second protrusion 28 is formed on the hood 22 of the housing 20 of the female connector 200.

The protrusions 18 and 28 are preferably aligned with each other in the mating direction (the direction in which the male connector 100 is inserted into the female connector 200) when the male connector 100 and the female connector 200 are mated with each other.

The first and second protrusions 18 and 28 are both cylindrical in the embodiment shown. One of the protrusions 18 and 28 has, at the tip end thereof, an expanded part 29 that projects outward.

A recess 27 for receiving the first protrusion 18 when the male connector 100 and the female connector 200 are mated with each other is formed in the hood 22 at a position close to the second protrusion 28.

This pair of connectors requires the recess 27 because the first protrusion 18, which prevents the tip end of a mating support member 300 described later from colliding against the back, is provided on the connector 10 at a position close to the front edge and would otherwise interfere with the front edge of the hood 22. However, the present invention is not limited to this configuration. The recess 27 may be omitted if the protrusions 18 and 28 can be widely spaced apart from each other, if the second protrusion 28 is formed at a position close to the front edge of the hood 22, or if the hood 22 is short, for example.

To mate the male connector 100 and the female connector 200 with each other, the mating support member 300 is used.

As shown in FIG. 1, the mating support member 300 includes a support member main body 30 that is flat plate shaped and made of a metal or a resin, and the support member main body 30 has a protrusion receiving passageway 31 and a cam section 32 formed therein. The mating support member 300 further has a lever part 33 that protrudes on the opposite side of the protrusion receiving passageway 31 across the cam section 32.

The protrusion receiving passageway 31 has an inner diameter equal to or slightly larger than the outer diameter of the first protrusion 18.

The cam section 32 has a first receiving passageway 32a formed in a part close to one end and a second receiving passageway 32b formed in a part close to the other end, and the first receiving passageway 32a and the second receiving passageway 32h have inner diameters larger than the outer diameter of the expanded part 29 of the second protrusion 28.

A part of the first receiving passageway 32a closer to the protrusion receiving passageway 31 is expanded to form a cam groove inlet 32c. The cam groove inlet 32c is continuous with a cam groove 32d having a predetermined shape.

The cam groove 32d has a width smaller than the outer diameter of the expanded part 29 of the second protrusion 28.

The cam groove 32d presses the outer peripheral part of the second protrusion 28 when the lever part 33 is pressed to rotate the mating support member 300 around the first protrusion 18 in the protrusion receiving passageway 31. The cam groove 32d can press the second protrusion 28 in opposite directions depending whether the lever part 33 rotates clockwise or counterclockwise.

Thus, one side of the cam groove 32d, at which the cam groove 32d presses the second protrusion 28 toward the first protrusion 18 to mate the male connector 100 and the female connector 200 with each other, is referred to as a mating pressing surface 32e mating pressing part), and the other side of the cam groove 32d, at which the cam groove 32d presses the second protrusion 28 away from the first protrusion 18 to decouple the male connector 100 and the female connector from each other, is referred to as a decoupling pressing surface 32f (decoupling pressing part).

Although not exclusively, the mating pressing surface 32e and the decoupling pressing surface 32f are shaped so that the force F2 applied to mate or decouple the male connector 100 and the female connector 200 with or from each other is higher than the frictional force μF1 between the mating pressing surface 32e or the decoupling pressing surface 32f and the second protrusion 28 when the lever part 33 is pressed to rotate the mating support member 300, thereby making the mating pressing surface 32e or the decoupling pressing surface 32f press the second protrusion 28.

To mate the male connector 100 and the female connector 200 with such a mating support member 300, the operator first gently inserts the male connector 100 into the hood 22 of the female connector 200, as shown in FIG. 1.

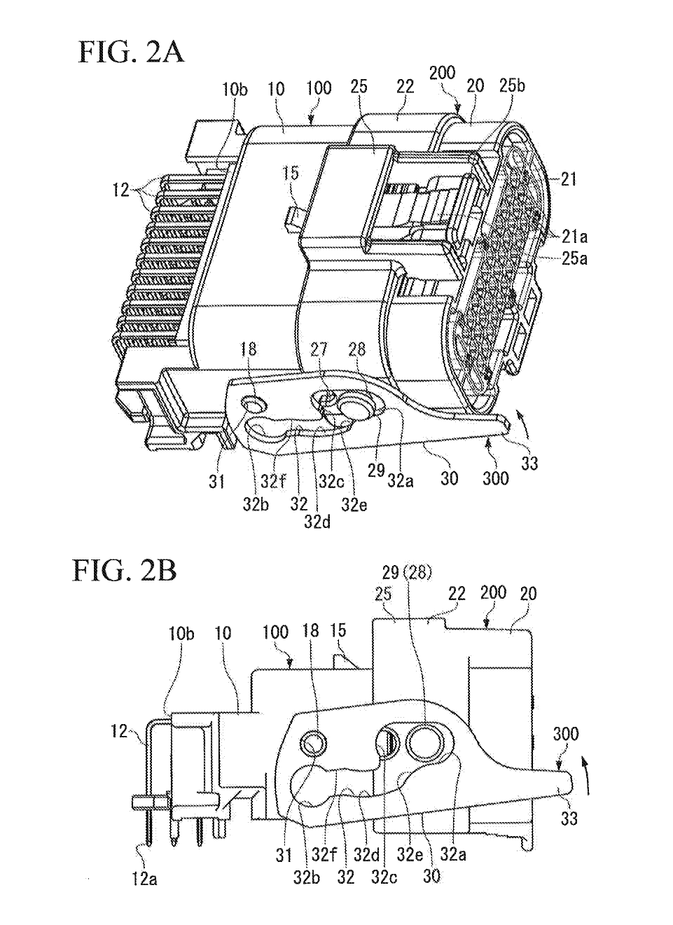

Then, as shown in FIGS. 2A and 2B, the first protrusion 18 on the male connector 100 is inserted into the protrusion receiving passageway 31 in the mating support member 300, and the second protrusion 28 on the female connector 200 is inserted into the first receiving passageway 32a of the cam section 32.

Then, the second protrusion 28 is moved from the first receiving passageway 32a of the cam section 32 to the cam groove inlet 32c. This movement can be achieved by the operator pressing the male connector 100 and the female connector 200 closer to each other or pressing the lever part 33 of the mating support member 300 in the direction indicated by the arrow in the drawing and thereby pressing the second protrusion 28 toward the cam groove inlet 32c.

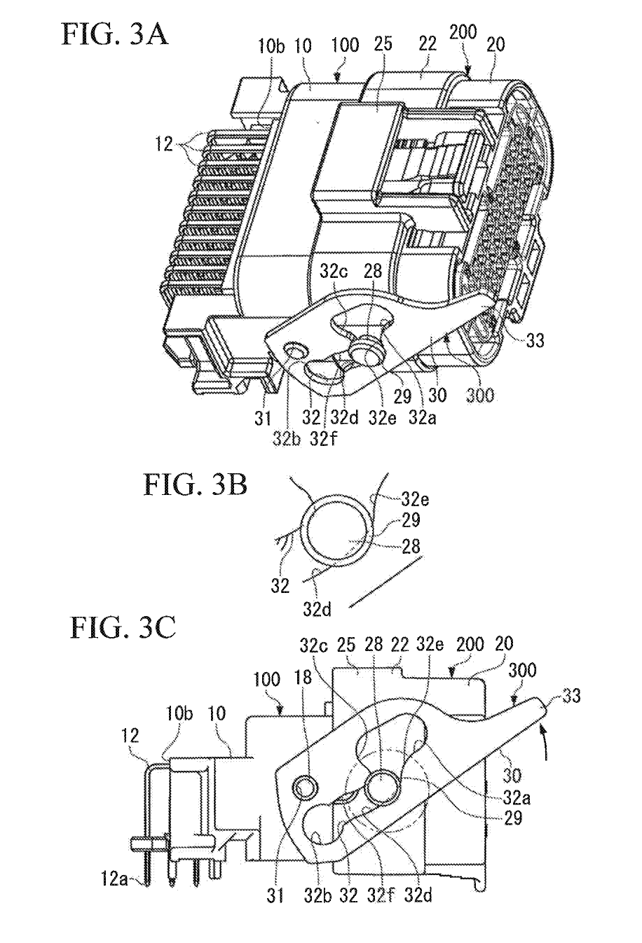

In this state, as shown in FIGS. 3A and 3C, the operator continues pressing the lever part 33 of the mating support member 300 in the counterclockwise direction in the drawing to further rotate the mating support member 300 around the protrusion receiving passageway 31. Then, the second protrusion 28 enters the cam groove 32d. Since the width of the cam groove 32d is smaller than the outer diameter of the expanded part 29 of the second protrusion 28 as shown in FIG. 3B, the second protrusion 28 is prevented from coming off the cam groove 32d.

In addition, as the mating pressing surface 32e presses the second protrusion 28, the process of mating of the male connector 100 and the female connector 200 proceeds. In this state, the lock 25 is engaged with the engaging member 15, and the process of mating of the male connector 100 and the female connector 200 further proceeds.

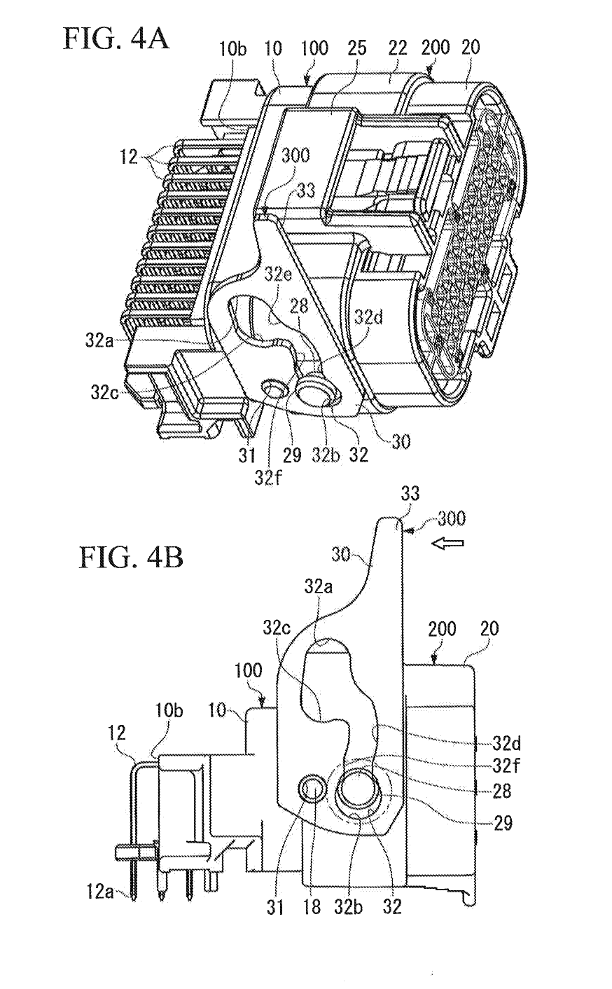

Then, as shown in FIGS. 4A and 4B, the lever part 33 is further rotated, and when the second protrusion 28 enters the second receiving passageway 32b from the cam groove 32d, the process of mating of the male connector 100 and the female connector 200 is completed.

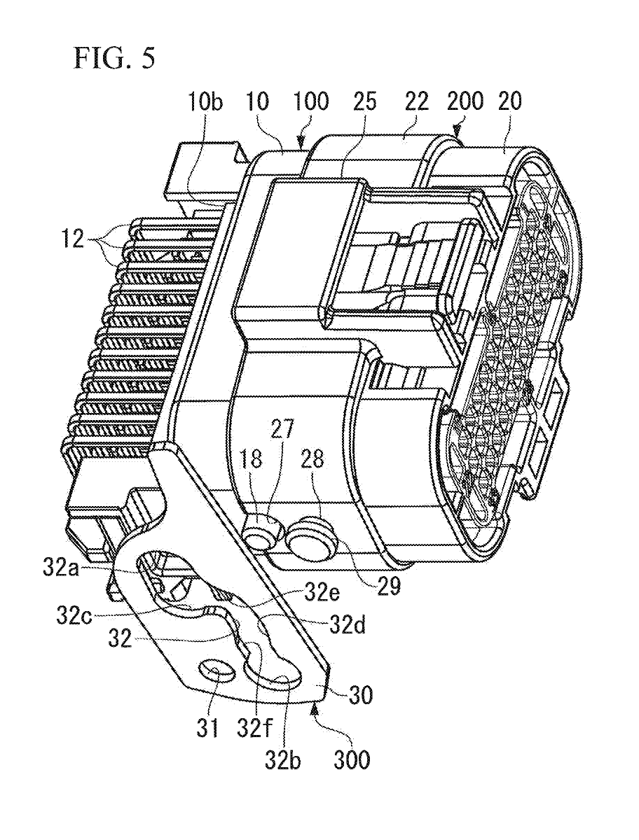

After that as shown in FIG. 5, the mating support member 300 is displaced sideward, and the protrusions 18 and 28 are drawn from the protrusion receiving passageway 31 and the second receiving passageway 32b, respectively.

In this way, the mating support member 300 can assist mating of the male connector 100 and the female connector 200.

To decouple the male connector 100 and the female connector 200 mated with each other, the process described above is performed in the reverse order, beginning with the state shown in FIG. 5 and ending with the state shown in FIG. 1, by rotating the lever part 33 in the opposite direction to the direction described above and pulling the male connector 100 out of the female connector 200.

In this way, with the mating support member 300, the male connector 100 and the female connector 200 can not only be easily mated with each other but also be easily decoupled from each other.

In addition, the mating support member 300 can be used not only for one pair of male and female connectors 100 and 200 but also for another pair of male and female connectors 100 and 200, so that the cost can be reduced.

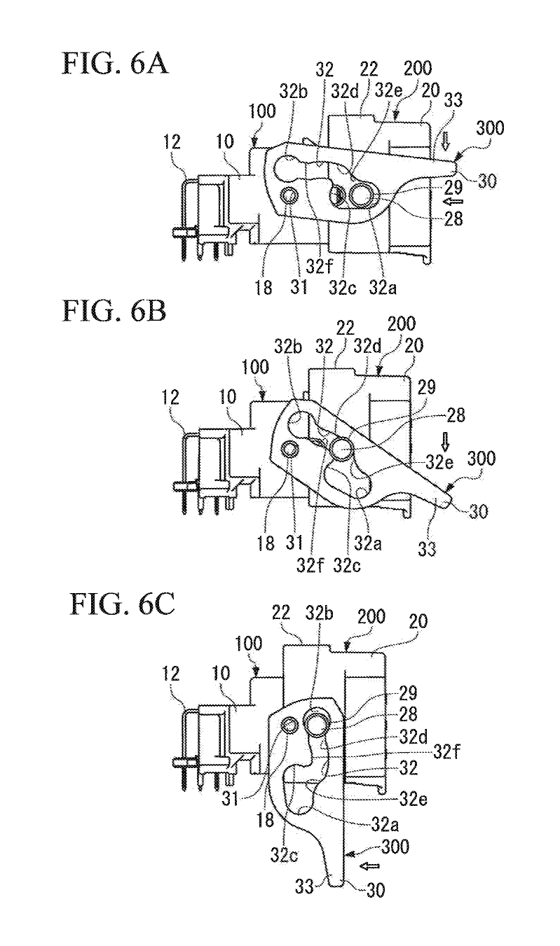

Furthermore, as shown in FIGS. 6A to 6C, the mating support member 300 can be turned inside out from the state shown in FIGS. 1 to 5 for use. This is possible because the protrusions 18 and 28 are arranged along the mating direction of the male connector 100 and the female connector 200.

Thus, the operator can carry out mating and decoupling of the connectors regardless of which side of the mating support member 300 is front or back and therefore can flexibly carry out the task according to the circumstances, such as the space in which the mating support member 300 is rotated. Thus, restrictions on the placement of the connectors are eased, and different kinds of mating support members 300 do not have to be prepared, and thus, the cost can be reduced.

The lever part 33 of the mating support member 300 described above may extend in different directions.

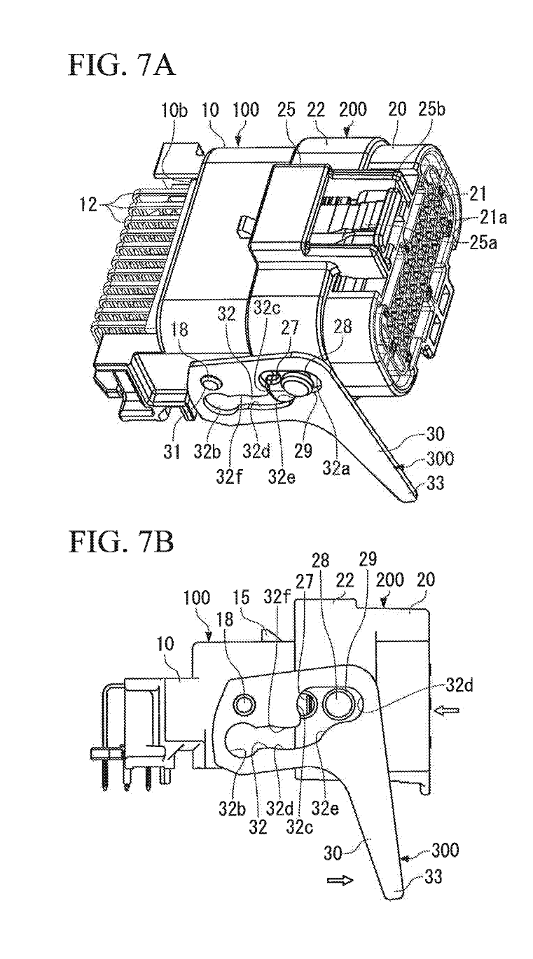

For example, as shown in FIGS. 7A and 7B, the lever part 33 may be formed to extend in a direction substantially perpendicular to the mating direction of the male connector 100 and the female connector or, of course, in other directions.

Such a mating support member 300 can also be turned inside out for use.

Although features of the male connector 100 and the female connector 200 according to an embodiment have been described above, the male connector 100 and the female connector 200 can have any configuration as long as the male connector 100 and the female connector 200 have the protrusions 18 and 28 configured.

The mating support member 300 may be used to mate the male connector 100 and the female connector 200 with each other or to decouple the male connector 100 and the female connector 200 from each other. Furthermore, the mating support member 300 may not be removable and may be rotatably coupled to the first protrusion 18 on the male connector 100.

In addition, since the first protrusion 18 on the first electrical connector 100 and the second protrusion 28 on the second electrical connector 200 are arranged in line along the direction of mating and decoupling of the first and second electrical connectors 100, 200, the first electrical connector 100 and the second electrical connector 200 can be mated with and decoupled from each other regardless of which side of the mating support member 300 is front or back. Thus, the mating support member 300 can be used regardless of the position or posture of the electrical connectors 100, 200 and is highly versatile. Even in a situation where different kinds of mating support members are needed, the number of mating support members can be reduced, since the mating support members can be used regardless of which side is front or back.

In other respects, the features described above with regard to the embodiment can be omitted, combined or modified as required without departing from the spirit of the present invention.

What is claimed is:

1. An electrical connector mating support member comprising:
a support member main body having a protrusion receiving passageway formed in the support member main body into which a first protrusion formed on a first electrical connector is inserted;
a lever disposed on the support member main body on the opposite side of the protrusion receiving passageway; and
a cam section formed in the support member main body between the protrusion receiving passageway and the lever and into which a second protrusion formed on the second electrical connector is inserted, the cam section having:
a first receiving passageway formed at one end of the cam section into which the second protrusion is insertable;
a second receiving passageway formed at another end of the cam section into which the second protrusion is insertable; and
a cam groove that is formed between and continuous with the first receiving passageway and the second receiving passageway and urges the second protrusion closer to or further away from the first protrusion when the lever rotates the support member main body around the first protrusion.

2. The mating support member according to claim 1, wherein the second protrusion has an expanded part at a tip end thereof.

3. The mating support member according to claim 2, wherein the first receiving passageway and the second receiving passageway have an inner diameter being larger than a diameter of the expanded part.

4. The mating support member according to claim 3, wherein the cam groove has a width being smaller than the diameter of the expanded part.

5. The mating support member according to claim 1, wherein the cam groove includes a mating pressing surface that engages and moves the second protrusion closer to the first protrusion when the support member main body is rotated in a first direction around the first protrusion.

6. The mating support member according to claim 5, further comprising a decoupling pressing surface that engages and moves the second protrusion away from the first protrusion when the support member main body is rotated in a second direction around the first protrusion.

7. A method of mating a first electrical connector to a second electrical connector using a mating support member, the method comprising the steps of:
providing a first protrusion on the first electrical connector;
providing a second protrusion on the second electrical connector;
providing a support member main body having a protrusion receiving passageway formed in the support member main body into which the first protrusion is inserted;
providing a lever disposed on the support member main body on the opposite side of the protrusion receiving passageway; and
providing a cam section formed in the support member main body between the protrusion receiving passageway and the lever and into which the second protrusion is inserted, the cam section having:
a first receiving passageway formed at one end of the cam section into m which the second protrusion is insertable;
a second receiving passageway formed at the other end of the cam section into which the second protrusion is insertable; and
a cam groove that is formed between and continuous with the first receiving passageway and the second receiving passageway and urges the second protrusion closer to or further away from the first protrusion when the lever rotates the support member main body around the first protrusion,
inserting the first protrusion into the protrusion receiving passageway and inserting the second protrusion into the first receiving passageway of the cam section;
rotating the lever such that the support member main body rotates around the first protrusion and the cam groove engages and urges the second protrusion closer to the first protrusion; and
removing the mating support member by pulling the first protrusion and the second protrusion out of the protrusion receiving passageway and the second receiving passageway, respectively, when the second protrusion enters the second receiving passageway.

8. The method of mating the first electrical connector to the second electrical connector according to claim 7, wherein the first protrusion and the second protrusion are arranged in line along a mating direction.
